(19) United States
(12) Patent Application Publication
(10) Pub. No.: US 2022/0347921 A1
(43) Pub. Date: Nov. 3, 2022

(54) 3D PRINTING SYSTEM

(71) Applicant: RYUJIN LAB, INC., Seongnam-si, Gyeonggi-do (KR)

(72) Inventors: Seong Jin PARK, Seogwipo-si (KR); Hong Joo LEE, Seoul (KR); Kihyung KIM, Yongin-si (KR)

(73) Assignee: RYUJIN LAB, INC., Seongnam-si, Gyeonggi-do (KR)

(21) Appl. No.: 17/761,422

(22) PCT Filed: Sep. 21, 2020
(86) PCT No.: PCT/KR2020/012678

§ 371 Date: Mar. 17, 2022

(30) Foreign Application Priority Data
Sep. 19, 2019 (KR) 10-2019-0115155
Sep. 16, 2020 (KR) 10-2020-0119402

(51) Int. Cl. B29C 64/282; B29C 64/129; B29C 64/286; B29C 64/30; B33Y 30/00

(52) U.S. Cl. CPC B29C 64/282; B29C 64/129; B29C 64/286; B29C 64/30; B33Y 30/00

(57) ABSTRACT

There are proposed a 3D printer optical engine and printing system capable of forming a single light engine by integrating light sources. A light engine installed under a tank accommodating a photocurable resin and configured to provide a light source for the molding of an output product to the tank includes: a light engine case detachably mounted under the tank, and having an accommodation space therein; a backlight module detachably installed in the lower portion of the accommodation space of the light engine case, and configured to provide backlight; and an image switching module detachably installed in the upper portion of the accommodation space of the light engine case while being spaced apart from the backlight module, and configured to cure the photocurable resin by radiating a light source corresponding to a tomographic image of the output product onto the tank.

### TECHNICAL FIELD

The embodiments disclosed herein relate to a 3D printing system, and more particularly to a 3D printing system capable of forming a single light engine by integrating light sources.

### BACKGROUND ART

In general, 3D printers (three-dimensional molding machines) are implemented with a technology that structures an object into considerably thin layers(slices) by using the 3D information of the object composed of a digital file and then implements an actual molded product by stacking materials layer by layer based on the information. Such 3D printers may be basically classified into a photocuring stacking type and an FDM(Fused Deposition Modeling) (or FFF:Fused Filament Fabrication) type.

Among them, the photocuring stacking-type method is designed to perform 3D printing by using a photocurable resin that cures when exposed to light. This is a technology that forms a molded product by curing resin in a region to be molded in such a manner as to radiate light from a light source that provides light to a barrel containing the resin.

A typical resin 3D printer is configured to include a backlight composed of LEDs and an image switching unit configured to provide a light source corresponding to a tomographic image for the molding of an output product. However, the conventional resin 3D printer has the inconvenience of arranging and fixing individual components one by one when the printer is fabricated because components constituting a light engine are not integrated but are formed to be separate.

Furthermore, the conventional resin 3D printer also has a problem in that it is cumbersome to replace the components constituting the light engine.

Moreover, the conventional resin 3D printer has a problem in that it does not secure a sufficient amount of light of the light source, and has a limitation in that it provides only a light source having the same wavelength.

As a related art, there is an LCD-type 3D printer that is disclosed in Korean Patent No. 10-800667.

This prior art also has problems in that the components of a light engine are formed to be separate and only a light source having the same wavelength is provided.

Therefore, there is a demand for technology for overcoming the above-described problems.

Meanwhile, the above-described background technology corresponds to technical information that has been possessed by the present inventor in order to contrive the present invention or that has been acquired in the process of contriving the present invention, and can not necessarily be regarded as well-known technology that had been known to the public prior to the filing of the present invention.

### DISCLOSURE

### Technical Problem

An object of the embodiments disclosed herein is to propose a 3D printing system which may be detachably mounted into a printer by integrating a backlight unit and an image switching unit constituting a light source with a case to form a single light engine module.

Another object of the embodiments disclosed herein is to propose a 3D printing system in which a backlight unit or an image switching unit may be easily replaced by forming the backlight unit and the image switching unit as respective modules.

Another object of the embodiments disclosed herein is to propose a 3D printing system in which an integrated light engine module may be formed as a self-luminous member and the self-luminous member may provide different wavelengths.

### Technical Solution

As a technical solution for overcoming the above-described technical problem, according to an aspect of the present invention, there is provided a 3D printing system including: a tank configured to accommodate a photocurable resin; and a light engine installed under the tank, and configured to provide a light source for the molding of an output product to the tank; wherein the light engine includes: a light engine case detachably mounted under the tank, and having an accommodation space therein; a backlight module detachably installed in the lower portion of the accommodation space of the light engine case, and configured to provide backlight; and an image switching module detachably installed in the upper portion of the accommodation space of the light engine case while being spaced apart from the backlight module, and configured to cure the photocurable resin by radiating a light source corresponding to a tomographic image of the output product onto the tank.

Furthermore, the backlight module may include: a heat sink disposed at the lower end of the light engine case, and configured to dissipate heat out of the light engine case; an LED board installed over the heat sink, mounted with a plurality of LEDs on the top surface thereof, and configured to provide backlight; and condensing lenses installed over the respective LEDs mounted on the LED board, and configured to collect the light of the LEDs and provide it to the image switching module.

Furthermore, the image switching module may include: an LCD unit installed at the upper end of the light engine case, and configured to radiate a light source corresponding to a tomographic image of the output product onto the tank; and a transparent support member installed under the LCD unit, and configured to prevent the LCD unit from sagging while transmitting the backlight, radiated from the backlight module, therethrough.

As a technical solution for overcoming the above-described technical problem, according to another aspect of the present invention, there is provided a 3D printing system including: a tank configured to accommodate a photocurable resin; and a light engine installed under the tank, and configured to provide a light source for the molding of an output product to the tank; wherein the light engine includes: a light engine case detachably mounted under the tank, and having an accommodation space therein; a heat sink detachably installed in the lower portion of the light engine case, and configured to dissipate heat out of the light engine case; and a self-luminous member installed over the heat sink, and configured to form a module along with the heat sink and to cure the photocurable resin by radiating high-resolution light corresponding to a tomographic image of the output product toward the tank.

Furthermore, the self-luminous member may include one or more main pixels each including any one of a micro-LED, an OLED, an FED, and an LED.

Furthermore, the self-luminous member may include one or more sub-pixels providing a light source having a wavelength different from that of the main pixels while each including any one of a micro-LED, an OLED, an FED, and an LED.

### Advantageous Effects

According to any one of the above-described technical solutions, there is proposed the 3D printing system in which the backlight module and the image switching module constituting a light source are integrated with the light engine case to form the single light engine, so that the 3D printing system may be easily mounted in or separated from a printer.

Furthermore, according to any one of the above-described technical solutions, there is proposed the 3D printing system in which the backlight module and the image switching module form independent modules and are mounted in the light engine case, so that only the image switching module or the backlight module may be easily replaced as needed.

Furthermore, according to any one of the above-described technical solutions, there is proposed the 3D printing system in which when the light engine is formed via the light engine case, the self-luminous member, and the heat sink, the component of the backlight may be omitted, thereby achieving a small size, and a high-resolution molded product may be output via a high-resolution light source.

Moreover, according to any one of the above-described technical solutions, there is proposed the 3D printing system in which the main pixels and the sub-pixels constituting the self-luminous member provide light having different wavelengths, so that output may be performed using a mixed resin that reacts to the individual wavelengths.

The effects that can be obtained by the embodiments disclosed herein are not limited to the effects described above, and other effects not described above will be apparently understood by those of ordinary skill in the art to which the present invention pertains from the following description.

### DESCRIPTION OF DRAWINGS FIG. 1 is a diagram showing the configuration of a 3D printing system according to an embodiment;

FIG. 2 is a diagram showing the configuration of a 3D printing system according to another embodiment; and

FIG. 3 is a diagram showing the configuration of a 3D printing system according to still another embodiment.

### MODE FOR INVENTION

Various embodiments will be described in detail below with reference to the accompanying drawings. The following embodiments may be modified to various different forms and then practiced. In order to more clearly illustrate features of the embodiments, detailed descriptions of items that are well known to those of ordinary skill in the art to which the following embodiments pertain will be omitted. Furthermore, in the drawings, portions unrelated to descriptions of the embodiments will be omitted. Throughout the specification, like reference symbols will be assigned to like portions.

Throughout the specification, when one component is described as being “connected” to another component, this includes not only a case where the one component is “directly connected” to the other component but also a case where the one component is “connected to the other component with a third component disposed therebetween.” Furthermore, when one portion is described as “including” one component, this does not mean that the portion does not exclude another component but means that the portion may further include another component, unless explicitly described to the contrary.

The embodiments will be described in detail below with reference to the accompanying drawings.

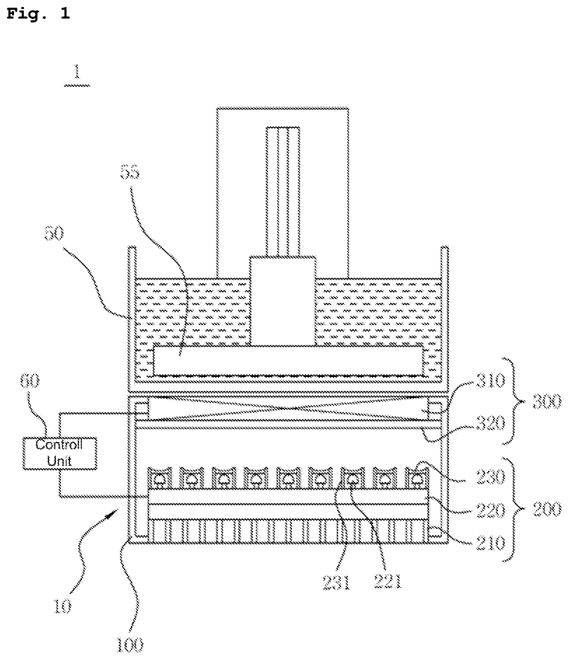

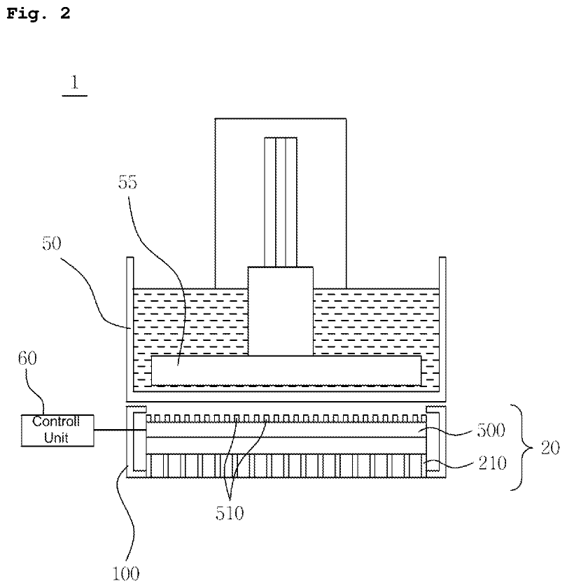

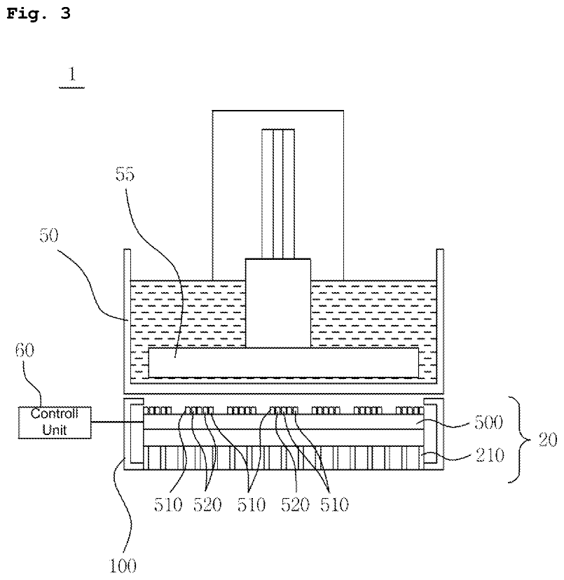

FIG. 1 is a diagram showing the configuration of a 3D printing system according to an embodiment, FIG. 2 is a diagram showing the configuration of a 3D printing system according to another embodiment, and FIG. 3 is a diagram showing the configuration of a 3D printing system according to still another embodiment.

The 3D printing system 1 according to the present embodiment may be configured to include a tank 50 and a control unit 60 as well as a light engine 10, as shown in FIG. 1.

The tank 50 is configured in the form of a container having an open top to accommodate a photocurable resin passed through by light.

In this case, the photocurable resin cures when it receives light from an LCD or the like, and all materials known in the art to which the present invention pertains, including a resin, may be applied.

The tank 50 may be installed over the light engine 10 to be described later, and may cure the photocurable resin while transmitting the light provided from the light engine 10 therethrough.

Furthermore, a plate 55 on which a cured photocurable resin can be stacked is installed in the tank 50 to be selectively lifted and lowered, so that a photocurable resin corresponding to a tomographic image can be stacked layer by layer. The control unit 60 may control the light engine 10 to be described later in order to provide a light source corresponding to a tomographic image.

The control unit 60 may control individual light emission regions while controlling a backlight module 200, an image switching module 300, and a self-luminous member 500 constituting the light engine 10 to be described later.

For example, while controlling the light emission regions of the backlight module 200 in conjunction with the image signals applied from the image switching module 300, the control unit 60 may turn on the backlight of the backlight module 200 in a region corresponding to a tomographic image for molding and turn off the backlight of the backlight module 200 in the remaining regions where a tomographic image is not displayed.

The light engine 10 is a component that is detachably mounted under the tank 50 described above and performs 3D printing while operating under the control of the control unit 60 and also providing a light source capable of curing the photocurable resin of the tank 50.

Referring to FIG. 1, the light engine 10 according to the present embodiment may be configured to include a light engine case 100, the backlight module 200, and the image switching module 300.

The light engine case 100 is a component that is mounted in the printing system 1 while constituting a single module along with the backlight module 200 and the image switching module 300 to be described later.

The light engine case 100 is formed in a housing shape with an open top end and an open bottom end, so that the backlight module 200 and the image switching module 300 can be detachably accommodated in an accommodation space therein.

The backlight module 200 is a component that is installed below the image switching module 300 to be described later and provides backlight.

The backlight module 200 may provide backlight under the control of the above-described control unit 60, and may also be partitioned into a plurality of regions and controlled for each partition or individually.

The backlight module 200 may be configured to include a heat sink 210, an LED board 220, and condensing lenses 230.

The heat sink 210 is a component that is installed at the lower end of the light engine case 100 and dissipates the heat generated from the LED board 220 out of the light engine case 100.

The LED board 220 is installed on top of the heat sink 210 and provides backlight for the output of a molded product from a location below the image switching module 300 to be described later. The LED board 220 may be mounted with a plurality of LEDs 221 thereon, and may provide backlight while radiating light under the control of the control unit 60. The LED board 220 may be configured to have an area corresponding to that of the image switching module 300 and provide backlight having the same size as the light emission area of the image switching module 300, and may form planar light through the plurality of LEDs 221, thereby improving the rectilinear propagation property of light and securing the uniformity and quantity of light.

In this case, the LED board 220 may include an array of any one type of elements selected from the group consisting of self-luminous display elements including micro-LEDs, LEDs, organic LEDs (OLEDs), and field emission displays (FEDs), and may include elements configured to provide light having a predetermined wavelength.

The condensing lenses 230 are components that condense the light of the LEDs 221 and provide it to the image switching module 300 to be described later.

The condensing lenses 230 may be installed at the upper ends of cylindrical lens caps 231 installed in a form that covers the plurality of respective LEDs 221 mounted on the LED board 220, and may condense the light of the LEDs 221 and provide it upward, so that the light radiated from the LEDs 221 can be radiated onto the image switching module 300 without loss.

The image switching module 300 is a component that cures the photocurable resin by radiating light corresponding to a tomographic image for the molding of an output product onto the tank 50.

The image switching module 300 may be detachably installed in the upper part of the accommodation space of the light engine case 100 while being spaced apart from the backlight module 200 by a predetermined distance, and may provide light corresponding to a tomographic image toward the tank 50 through the control of the control unit 60.

In other words, the image switching module 300 may be mounted in or separated from the printing system 1 while constituting a single integrated light engine module along with the backlight module 200 and the light engine case 100.

Furthermore, the image switching module 300 and the backlight module 200 are each configured to be independently and detachably mounted in the light engine case 100, so that it can be easily replaced as needed.

In this case, the image switching module 300 may be configured to include an LCD unit 310 and a transparent support member 320. The LCD unit 310 may be installed at the upper end of the light engine case 100, and may cure the photocurable resin accommodated in the tank 50 in the form of a tomographic image by radiating light corresponding to a tomographic image of an output product onto the tank 50 while operating under the control of the control unit 60.

The transparent support member 320 is a component that prevents the LCD unit 310 from sagging, thereby enabling the LCD unit 310 to have a large area.

The transparent support member 320 may be installed in close contact with the bottom of the LCD unit 310 and prevent the LCD unit 310 from sagging due to its own weight, and may transmit the backlight, radiated from the backlight module 200, therethrough to the LCD unit 310.

As described above, according to the light engine 10 of the 3D printing system 1 according to the present embodiment, the backlight module 200 and the image switching module 300 constituting a light source are integrated with the light engine case 100 to form a single light engine, so that they can be easily mounted in or separated from the printing system.

Meanwhile, referring to FIG. 2, the light engine 20 of a 3D printing system 1 according to another embodiment may be configured to include a light engine case 100, a heat sink 210, and a self-luminous member 500.

In this case, since the light engine case 100 and the heat sink 210 are the same as described above, detailed descriptions thereof will be omitted.

The self-luminous member 500 is a component that provides a high-resolution light source in place of the above-described backlight module 200 and image switching module 300. The self-luminous member 500 may be installed on the heat sink 210 and be mounted in the printing system 1 while constituting one light engine module along with the heat sink 210 and the light engine case 100, and may radiate high-resolution light corresponding to a tomographic image of an output product onto the tank 50 while operating under the control of the control unit 60.

In this case, the self-luminous member 500 may include an array of any one type of elements selected from the group consisting of self-luminous display elements including micro-LEDs, LEDs, OLEDs, and FEDs, and may include a plurality of main pixels 510 including elements that provide light having a predetermined wavelength.

Accordingly, the light engine 20 according to the present embodiment may be formed in a small size by omitting the component of the backlight module 200, and may output a high-resolution molded product by providing high-resolution light.

Meanwhile, referring to FIG. 3, a self-luminous member 500 may further include sub-pixels 520.

The sub-pixels 520 are components that provide light having a wavelength different from that of main pixels 510. Each of the sub-pixels 520 may include any one selected from the group consisting of self-luminous display elements including a micro-LED, an LED, an organic LED, and a field emission display (FED), and may provide light having a wavelength different from that of the main pixels 510 to the tank 50 while radiating light under the control of the control unit 60.

Accordingly, a light engine 20 according to still another embodiment may perform the 3D printing of a molded product through a mixed resin that reacts to the wavelengths of the main pixels 510 and the sub-pixels 520.

As described above, according to the light engine 20 of the 3D printing system 1 according to the present embodiment, a small size may be achieved because the component of the backlight may be omitted via the self-luminous member 500, a high-resolution molded product may be output via a high-resolution light source, and output may be performed using a mixed resin reacting to individual wavelengths because the main pixels 510 and the sub-pixels 520 constituting the self-luminous member 500 provide light having different wavelengths.

The above-described embodiments are intended for illustrative purposes. It will be understood that those of ordinary skill in the art to which the present invention pertains can easily make modifications and variations without changing the technical spirit and essential features of the present invention. Therefore, the above-described embodiments are illustrative and are not limitative in all aspects. For example, each component described as being in a single form may be practiced in a distributed form. In the same manner, components described as being in a distributed form may be practiced in an integrated form. The scope of protection pursued via the present specification should be defined by the attached claims, rather than the detailed description. All modifications and variations which can be derived from the meanings, scopes and equivalents of the claims should be construed as falling within the scope of the present invention.

1. A 3D printing system comprising:
a tank configured to accommodate a photocurable resin; and
a light engine installed under the tank, and configured to provide a light source for molding of an output product to the tank;
wherein the light engine comprises:
a light engine case detachably mounted under the tank, and having an accommodation space therein;
a backlight module detachably installed in a lower portion of the accommodation space of the light engine case, and configured to provide backlight; and
an image switching module detachably installed in an upper portion of the accommodation space of the light engine case while being spaced apart from the backlight module, and configured to cure the photocurable resin by radiating a light source corresponding to a tomographic image of the output product toward the tank.

2. The 3D printing system of claim 1, wherein the backlight module comprises:
a heat sink disposed at a lower end of the light engine case, and configured to dissipate heat out of the light engine case;
an LED board installed over the heat sink, mounted with a plurality of LEDs on a top surface thereof, and configured to provide backlight; and
condensing lenses installed over the respective LEDs mounted on the LED board, and configured to collect light of the LEDs and to provide it to the image switching module.

3. The 3D printing system of claim 1, wherein the image switching module comprises:
an LCD unit installed at an upper end of the light engine case, and configured to radiate a light source corresponding to a tomographic image of the output product onto the tank; and
a transparent support member installed under the LCD unit, and configured to prevent the LCD unit from sagging while transmitting the backlight, radiated from the backlight module, therethrough.

4. A 3D printing system comprising:
a tank configured to accommodate a photocurable resin; and
a light engine installed under the tank, and configured to provide a light source for molding of an output product to the tank;
wherein the light engine comprises:
a light engine case detachably mounted under the tank, and having an accommodation space therein;
a heat sink detachably installed in a lower portion of the light engine case, and configured to dissipate heat out of the light engine case; and
a self-luminous member installed over the heat sink, and configured to form a module along with the heat sink and to cure the photocurable resin by radiating high-resolution light corresponding to a tomographic image of the output product toward the tank.

5. The 3D printing system of claim 4, wherein the self-luminous member comprises one or more main pixels each including any one of a micro-LED, an OLED, an FED, and an LED.

6. The 3D printing system of claim 5, wherein the self-luminous member comprises one or more sub-pixels providing a light source having a wavelength different from that of the main pixels while each including any one of a micro-LED, an OLED, an FED, and an LED.
